(19) United States
(12) Patent Application Publication
(10) Pub. No.: US 2005/0090391 A1
(43) Pub. Date: Apr. 28, 2005

(54) Catalyst oxide for changing quality of fossil fuel

(76) Inventor: Niro Funagayama, Himezi-shi (JP)

Correspondence Address: JORDAN AND HAMBURG LLP, 122 EAST 42ND STREET, SUITE 4000, NEW YORK, NY, 10168, US

(21) Appl. No.: 10/755,780

(22) Filed: Jan. 12, 2004

(30) Foreign Application Priority Data
Oct. 28, 2003 (JP) 2003-367623

(51) Int. Cl. B01J 23/00; B01J 23/42; B01J 23/44

(52) U.S. Cl. 502/304; 502/349; 502/340; 502/339

(57) ABSTRACT

An object of the invention is to provide a catalyst capable of reducing both the black smoke quantity and the NOx quantity in exhaust gases. This invention provides, in a catalyst oxide for changing quality of fuel arranged between a petroleum fuel tank and a combustion chamber of the engine, a catalyst oxide for changing quality of fossil fuel, said catalyst oxide having, as main components, cerium oxide, zirconium oxide, thorium oxide, magnesium oxide and clay, comprising a ceramics catalyst oxide for subjecting petroleum fuel having said main components reduction-sintered to contact decomposition, and a catalyst oxide containing platinum·rhenium or palladium.

### FIELD OF THE INVENTION

This invention relates to a catalyst oxide of a low fuel cost and a low public hazard, which changes the quality of petroleum fuel; considerably reduces the black smoke quantity, NOx quantity, CO quantity, HC quantity, and PM quantity; causes them power-up; and enhances fuel costs.

### BACKGROUND OF THE INVENTION

In new vehicles or vehicles of which travel distance is less than tens of thousands of km, the combustion efficiency of the engine is so good that the mixed quantity of poisonous gases in exhaust gases is also low in level.

However, when the travel distance increases after use for a long period of years, the combustion efficiency lowers, and the generated quantity of poisonous gases increases. Particularly, in the Diesel engine which uses light oil as fuel, the black smoke quantity and NOx quantity in the discharge gases increase, which is one of significant causes of atmospheric contaminations.

As methods for solving the above-described problems, some efforts have been heretofore made. However, most of the prior methods are that a device is mounted at a part of the exhaust pipe, and mainly, the exhaust gases after combustion are adsorbed or processed by a catalyst, and the aforementioned methods were methods have nothing to do with an improvement in combustion efficiency of fuel.

As a method for enhancing the combustion efficiency of fuel, there has been used an active agent or the like which is used while being projected into a fuel tank directly, or being filled into a vessel provided in a passage from a fuel tank to a combustion chamber of the engine. However, in the actual circumstances, there involves many problems to be solved such that the performance or physical features of the active agent is incomplete, thus still being low in practicality.

Only the black smoke quantity in the exhaust gases can be reduced easily. However, when the black smoke quantity is reduced, the NOx quantity increases; and when the NOx quantity is reduced, the black smoke quantity increases. It is therefore extremely difficult to reduce both the black smoke quantity and the NOx quantity.

That is to say, this is because of the fact that if there is employed a condition in which fire retardant components in petroleum are completely burnt, the black smoke quantity reduces but nitrogen is also oxidized inevitably, and therefore, the NOx quantity also increases.

### SUMMARY OF THE INVENTION

It is an object of this invention to provide a catalyst capable of reducing both the black smoke quantity and the NOx quantity.

It is a further object of the invention to provide a ceramics catalyst which changes quality so that fossil fuel is subjected to contact decomposition to be burnt easily.

For accomplishing the above-described objects, the present invention provides, in a catalyst oxide for changing quality of fuel arranged between a petroleum fuel tank and a combustion chamber of the engine, a catalyst oxide for changing quality of fossil fuel, said catalyst oxide having, as main components, cerium oxide, zirconium oxide, thorium oxide, magnesium oxide and clay, comprising a ceramics catalyst oxide for subjecting petroleum fuel having said main component reduction-sintered to contact decomposition, and a catalyst oxide containing platinum·rhenium or palladium.

Preferably, said catalyst oxide containing platinum·rhenium or palladium is used in 1.0 to 1.5 weight % with respect to said ceramics catalyst.

Preferably, in said reduction sintering, reduction is carried out at 800 to 850° C., and sintering is carried out at 1200 to 1500° C.

Preferably, said sintering is carried out while raising and lowering a temperature of over 100° C. plural times within a range of temperatures of 1200 to 1500° C.

It is suitable for changing quality of light oil fuel that said ceramics catalyst oxide is a platinum·rhenium catalyst, and contains tin oxide:0.3 to 0.5 weight %, copper oxide:0.2 to 0.4 weight %, and cobalt: 0.7 to 1.3 weight %.

Said catalyst oxide is a catalyst containing palladium, and said catalyst which contains palladium, magnesium, nickel and molybdenum is suitable, as a catalyst for changing quality of A heavy oil fuel.

The present invention provides a ceramics catalyst oxide for subjecting petroleum fuel to contact decomposition having, as main components, cerium oxide, zirconium oxide, thorium oxide, magnesium oxide and clay, which are subjected to reduction sintering.

Said ceramics catalyst oxide is suitable for changing quality of light oil fuel to further contain tin oxide:0.3 to 0.5 weight %, copper oxide:0.2 to 0.4 weight %, and cobalt oxide:0.7 to 1.3 weight %.

Preferably, said ceramics catalyst oxide changes quality of fossil fuel further containing tin oxide:0.5 to 2.0 weight %, molybdenum oxide:0.5 to 3.0 weight %, and nickel oxide:0.5 to 2.0 weight %.

### BRIEF DESCRIPTION OF THE INVENTION

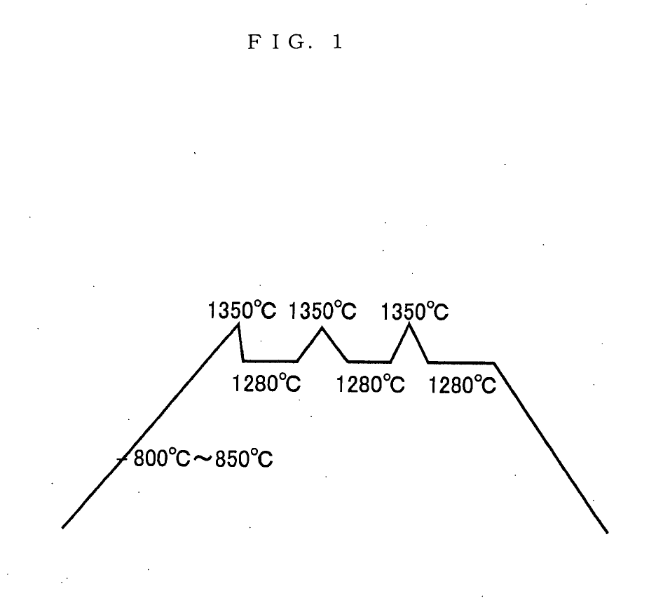

FIG. 1 is a diagram showing temperatures and time for reduction sintering a ceramics catalyst according to the present invention.

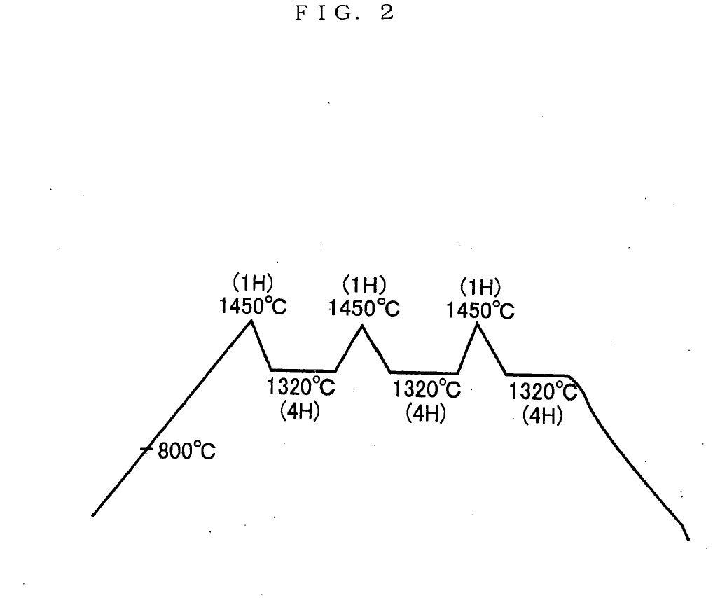

FIG. 2 is a further diagram showing temperatures and time for reduction sintering another ceramics catalyst according to the present invention.

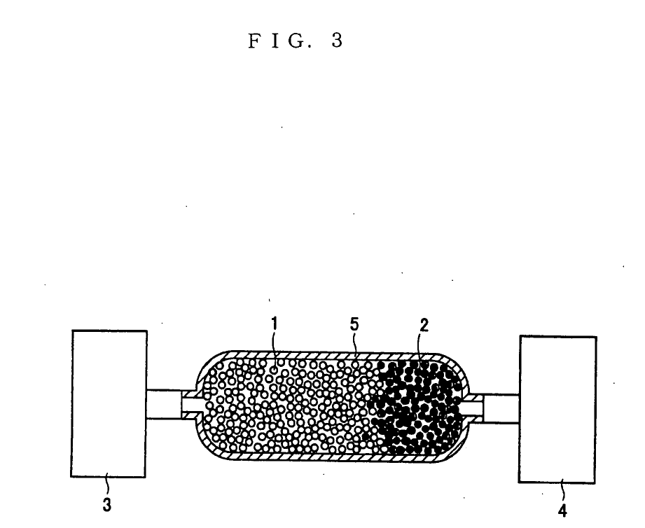

FIG. 3 is a schematic view showing the state that uses a catalyst according to the present invention.

### DETAILED DESCRIPTION OF THE PREFERRED EMBODIMENT

The embodiments of the present invention will be described hereinafter.

The ceramics catalyst according to the present invention has been believed to be a novel catalyst not described in the references, but is a ceramics catalyst having main components comprising clay as a matrix component, and cerium oxide, zirconium oxide, thorium oxide and magnesium oxide and clay, and has a function to subject petroleum fuel to contact decomposition. As a result, both the black smoke quantity and the NOx quantity can be reduced.

More specifically, preferred is a ceramics catalyst having, as main components, cerium oxide, zirconium oxide, thorium oxide and magnesium oxide and clay, which are subjected to reduction sintering.

The ceramics catalyst used in the present invention has a function so that petroleum fuel is subjected to contact decomposition to change it to that contains many small particles, mixing of fine fuel drop spraying and air in the engine combustion chamber is facilitated so as to more completely burn fuel.

The fact that the ceramics catalyst used in the present invention causes subjecting petroleum fuel to contact decomposition is presumed from that the volatile components of fossil fuel are increased by the catalyst of the present invention.

The mixing rate of the above-described components is, preferably, CeO₂: 35 to 40 weight part, ThO₂: 20 to 25 weight part, ZrO₂: 20 to 25 weight part, and MgO₂: 15 to 18 weight part, the remainder being clay oxide.

For changing quality of light oil fuel, it is preferable to further contain SnO₂: 0.3 to 0.5 weight part, CuO₂: 0.2 to 0.4 weight part, and CoO: 0.3 to 1.3 weight part.

For changing quality of A heavy oil fuel, it is preferable to further contain tin oxide:0.5 to 2.0 weight %, molybdenum oxide:0.5 to 3.0 weight %, and Nickel oxide:0.5 to 2.0 weight %.

If clay is too little, compression strength and wear reduction quantity of a catalyst are reduced, whereas if too much, catalyst effect is reduced. As clay, particularly, use of clay oxide is preferable.

If quantities of thorium and cerium are too little, reduction of NOx is insufficient, whereas too much, the black smoke quantity increases.

Since any of zirconium, tin and cobalt has a function to reduce the black smoke quantity, if zirconium having great effect is allowed to be present, absence of other components will suffice. However, when such three elements as described are allowed to be present, the black smoke quantity can be reduced remarkably.

The above-described components are fine powder, and preferably, are mixed in grain size: 10 to 15 micron, which is subjected to reduction sintering to provide the ceramics catalyst of the present invention.

If the grain size is too fine, handling is inconvenient, whereas too large, the water absorptive rate of the ceramics catalyst to be produced increases to drop the catalyst effect.

Preferably, the reduction sintering is carried out at 800 to 1500° C. Less than at 800° C., sintering is so insufficient as not to obtain the required strength, whereas in excess of 1500° C., a low melting-point substance is reacted to generate gases so that pores are generated in the inside and surface of ceramics to lower the strength. For the catalyst for light oil fuel, the reduction sintering is preferably carried out at 800 to 1400° C., and for A heavy oil fuel, the reduction sintering is preferably carried out at 800 to 1500° C.

Preferably, in the reduction sintering, reduction is carried out at 800 to 850° C., and sintering is carried out while raising and lowering a temperature a plurality of times about 100° C. within the temperature range of 1200 to 1400° C. (1300 to 1500° C.). More specifically, preferably, sintering is done while raising and lowering the temperature plural times between 1200 to 1400° C. such that sintering is done by raising the temperature from 800° C. to 1300 to 1400° C. (1400 to 1500° C.), after which sintering is done by lowering the temperature of about 100° C., and sintering is done by raising the temperature to 1300 to 1400° C. (1400 to 1500° C.) whereby the catalyst excellent in performance can be obtained. Further, it is better that the width for raising and lowering a temperature is made gradually small. It is noted that with respect to the temperatures indicated in both inside and outside of the parenthesis, the outside of the parenthesis is for the case of light oil fuel, while the inside of the parenthesis is for the case of A heavy oil fuel.

The above-mentioned ceramics catalyst and the catalyst oxide containing platinum·rhenium or palladium are used together. Preferably, for changing quality of light oil fuel, the catalyst oxide of platinum·rhenium is used, and for changing quality of A heavy oil fuel, the catalyst oxide containing palladium is used.

The catalyst oxide containing platinum·rhenium or palladium and the catalyst containing ceramics may be merely mixed, but preferably, use is made such that the catalyst oxide containing platinum·rhenium or palladium is coated on the catalyst containing ceramics. Use may be made such that the coated catalyst oxide and the catalyst containing ceramics are mixed, but preferably, they are filled in the same container or separately in separate containers. In case of filling in a stainless steel case between the tank and the engine, preferably, the coated catalyst oxide is filled on the engine side, and the catalyst containing ceramics is filled on the tank side.

Preferably, the mixing rate between the ceramics catalyst and the catalyst oxide containing platinum·rhenium or palladium is 1.0 to 1.5 weight %. If it is smaller than 1.0 weight %, the black smoke quantity lowers but the NOx quantity increases; while if larger than 1.5 weight %, the NOx quantity lowers but the black smoke quantity increases.

As the catalyst oxide containing palladium, preferred is a catalyst oxide containing palladium: 40 to 60 weight %, magnesium: 10 to 20 weight %, nickel: 10 to 20 weight %, and molybdenum: 15 to 25 weight %.

Preferably, the catalyst ceramics according to the present invention has the water absorptive rate (according to JIS R 2205): 1.5% or less, compression strength (according to JIS A5210): 6, 000 kg/cm² or more, and wear reduction quantity (according to JIS A5209 7.8): 0.1 g or less.

If the water absorptive rate increases, the catalyst ability reduces, and therefore, preferably, it is closest to zero if possible.

Further, if the catalyst ceramics is designed as described above, damages such as defect or wear relative to the vibration or shock during the travel when mounted on the vehicle can be reduced, and the catalyst ceramics can be used stably and economically for a long period.

When the catalyst ceramics remains in contact with fuel for a long period of time, there occurs a phenomenon in which fuel components are penetrated thereinto from pores in the ceramics body. For exhibiting the catalyst function, it is preferable to be large in surface area of ceramics and porous, but the permeation of fuel components causes the composition of ceramics to be fragile, resulting in the peel-off of the surface or breakage.

Ceramics grains are dipped into fuel for 720 hours, and as a result of compression test before and after the dipping, it has been found that when the water absorptive rate of ceramics grains according to JIS R2205 exceeds 1%, a deterioration in strength occurs.

The damages of the catalyst ceramics (for example, such as breakage or wear of ceramics caused by vibrations during the travel of vehicle) result in not only the economical loss due to the shortening of life of the ceramics but also the entry of grains or fine powder generated due to the breakage thereof into the combustion chamber resulting in the cause of damage to the engine portion or the cause of clogging of a filter, of which influence is extremely significant.

The wear resistance of the catalyst ceramics was measured in the procedure such that ceramics different in wear resistance are filled into a metal container, and are loaded on the vehicle (truck) to travel for about 150 hours for a period of about one month, after which the reduction quantity of ceramics grains before and after thereof is checked.

As a result, in a sample exceeding 0.2 g in a measured value (wear reduction quantity) measured by a head type wear tester according to JIS A52097.8 (pottery tile), a small trace of wear was found, but in case of 0.1 g or less, no trace of wear was found.

The present invention will be further described hereinafter with reference to the embodiments, but the present invention is not limited to these embodiments.

Embodiment 1

Clay oxide:8.8 weight % is mixed with CeO₂: 35.7 weight %, ThO₂: 20 weight %, ZrO₂: 20 weight %, SnO₂O: 0.3 weight %, CuO₂: 0.2 weight %, CoO: 0.7 weight %, and MgO₂: 15 weight % to crush them to grain size 250 mesh.

Water is added to the mixture, blended and molded, which is placed in a reduction calcinations state at 800 to 850° C. in a reduction furnace, and a temperature is raised to 1350° C. to effect sintering. The calcinations conditions are that as shown in FIG. 1, there are taken four hours to raise a temperature to 1350° C., 30 minutes to lower a temperature down to 1280° C., and maintained three hours in a state of 1280° C.; a temperature is raised to 1350° C. for 30 minutes, and a temperature is lowered to 1280° C. for 30 minutes to maintain it for three hours; and a temperature is raised to 1350° C. for 30 minutes, and a temperature is lowered to 1280° C. for 30 minutes to effect sintering for four hours.

The thus obtained ceramics catalyst can be used in a variety of shapes. In case of a spherical shape, if a diameter of about 8 to 10 mm is employed, a contact area becomes large, thus being effective.

Embodiment 2

Clay oxide:15.7 weight % is mixed with Ce: 27 weight %, Co: 7 weight %, Th: 20 weight %, Zr: 18 weight %, Mg: 4 weight %, Sn: 1.2 weight %, Pd: 4.8 weight %, Ni:0.9 weight %. and Mo:1.4 weight % to crush them to 250 mesh.

Water is added to the mixture, blended and molded, which is placed in a reduction calcinations state at 800° C. in a reduction furnace, and a temperature is raised to 1450° C. to effect sintering. The calcinations conditions are that as shown in FIG. 2, there are taken three hours to raise a temperature to 1450° C., maintained one hour at a temperature of 1450° C., maintained four hours lowering a temperature from 1450° C. to 1320° C. for 30 minutes, one hour raising a temperature to 1450° C. to for 30 minutes, four hours lowering a temperature to 1320° C. for 30 minutes, one hour raising a temperature to 1450° C. to for 30 minutes, and lowering a temperature to 1320° C. for 30 minutes to effect sintering for four hours.

The thus produced catalyst oxide of ceramics is made to be spherical (8 to 10 mm), to which are added palladium: 50 weight %, magnesium: 15 weight %, nickel: 15 weight %, and molybdenum: 20 weight % to obtain a catalyst, which is coated within 2 mm, which is added in the amount of 20 weight % of the whole weight, which is filled into a stainless steel container, and test was done by a 2-t boiler using A heavy oil made of Takuma Co., Ltd. for three months. The results were that the NOx quantity was reduced by 60%, and the fuel cost could be reduced by 14%.

The above-described product was mounted between the fuel tank in an independent electric power plant using A heavy oil and the engine plant and was tested. The result after passage of six months was that the NOx quantity was reduced by 63%, and the fuel cost was also reduced by 14%.

Embodiment 3

The catalyst oxide of ceramics 1 produced according to the above-described embodiment is made to be spherical (8 to 10 mm), on which is coated a platinum·rhenium catalyst within 2 mm 2, about 20 weight % of the total weight of which is added to obtain a catalyst oxide of ceramics, which was filled into a stainless steel container 5 connected to a piping between a light oil fuel tank 3 and an engine 4 of Diesel engine vehicle·KC-WGE4T and KC-WGEAT (2t vehicle) of Matuda as shown in FIG. 3. The black smoke quantity, NOx quantity (g/kwh), CO quantity (g/kwh), HC quantity (g/kwh), and PM quantity (g/kwh) were tested by Foundational juridical person: Nihon Automobile Transport Technical Association. The results are as given in Table 1 below.

TABLE 1

| Discharge gas components | CO | HC | NOx | PM |
|---|---|---|---|---|
| Test results of Akishima Laboratory | 5.781 | 1.420 | 4.558 | 0.694 |
| National reference values(2-t vehicle) | 9.200 | 3.800 | 7.800 | 0.960 |
| Measured values prior to mounting | 10.372 | 5.662 | 9.016 | 1.311 |

Discharge gases of a Diesel middle vehicle of more than 0.7 t to less than 2.5t were subjected to Diesel 13 mode test and PM test, as will be apparent from the above-described results, as a consequence of which all the discharge gas component has not reached to the national reference value before mounting, but after mounting, all the discharge gas component has cleared the national reference value.

For the purpose of comparison, even in case where the product having coated within 2 mm on the spherical shape (8 to 10 mm) of the platinum·rhenium was used in the quantity of about 15 weight % of the entire weight, the NOx quantity, CO quantity, HC quantity and PM quantity could be reduced considerably. The result is given in Table 2 below.

TABLE 2

| Discharge gas components | CO | HC | NOx | PM |
|---|---|---|---|---|
| Test results of Akishima Laboratory | 4.188 | 1.056 | 4.467 | 0.733 |
| National reference values(2-t v hicle) | 9.200 | 3.800 | 7.800 | 0.960 |
| Measured values prior to mounting | 9.152 | 4.355 | 8.639 | 1.674 |

The present invention exhibits, the great effect, that is not seen at all in this kind of conventional catalysts, in which the fossil fuel prior to combustion is changed in quality and used in combination with other catalysts, whereby both the black smoke quantity and NOx quantity can be reduced remarkably.

Further, the ceramics catalyst of the present invention exhibits a function, that is not seen at all in this kind of catalyst, in which fossil fuel is subjected to contact decomposition, and therefore, it is combined with other catalysts to thereby obtain the effect, that is not obtained conventionally, both the black smoke quantity and NOx quantity can be reduced remarkably.

1. In a catalyst oxide for changing quality of fuel arranged between a fossil fuel tank and a combustion chamber of the engine, a catalyst oxide for changing quality of fossil fuel, said catalyst oxide having, as main components, cerium oxide, zirconium oxide, thorium oxide, magnesium oxide and clay, comprising a ceramics catalyst oxide for subjecting petroleum fuel having said main component reduction-sintered to contact decomposition, and a catalyst oxide containing platinum·rhenium or palladium.

2. The catalyst oxide according to claim 1, wherein said catalyst oxide containing platinum rhenium or palladium is used in 1.0 to 1.5 weight % with respect to said ceramics catalyst.

3. The catalyst oxide according to claim 2, wherein in said reduction sintering, reduction is carried out at 800 to 850° C., and sintering is carried out at 1200 to 1500° C.

4. The catalyst oxide according to claim 3, wherein said sintering is carried out while raising and lowering a temperature of about 100° C. plural times within a range of temperatures of 1200 to 1500° C.

5. The catalyst for changing quality of light oil fuel according to claim 4, wherein said catalyst oxide is a platinum·rhenium catalyst, and contains tin oxide:0.3 to 0.5 weight %, copper oxide:0.2 to 0.4 weight %, and cobalt: 0.7 to 1.3 weight %.

6. The catalyst for changing quality of A heavy oil fuel according to claim 5, wherein said catalyst oxide is a catalyst containing palladium, and said catalyst contains palladium, magnesium, nickel and molybdenum.

7. A ceramics catalyst oxide for subjecting petroleum fuel to contact decomposition having, as main components, cerium oxide, zirconium oxide, thorium oxide, magnesium oxide and clay, which are subjected to reduction sintering.

8. The catalyst according to claim 7, wherein said ceramics catalyst oxide changes quality of light oil fuel further containing tin oxide:0.3 to 0.5 weight %, copper oxide:0.2 to 0.4 weight %, and cobalt oxide:0.7 to 1.3 weight %.

9. The catalyst according to claim 7, wherein said ceramics catalyst oxide changes quality of fossil fuel further containing tin oxide:0.5 to 2.0 weight %, molybdenum oxide:0.5 to 3.0 weight %, and nickel oxide:0.5 to 2.0 weight %.
